(19) United States
(12) Patent Application Publication
(10) Pub. No.: US 2024/0029937 A1
(43) Pub. Date: Jan. 25, 2024

(54) MAGNETIC ASSEMBLY

(71) Applicant: Elytone Electronic Co. Ltd, Taipei (TW)

(72) Inventors: Yen-Hao Chen, New Taipei City (TW); Te-Fang Chao, New Taipei City (TW)

(73) Assignee: Elytone Electronic Co. Ltd, Taipei (TW)

(21) Appl. No.: 17/899,594

(22) Filed: Aug. 30, 2022

(30) Foreign Application Priority Data
Jul. 22, 2022 (TW) 111127573

(51) Int. Cl. H01F 27/24; H01F 27/28; H01F 27/02; H01F 3/14

(52) U.S. Cl. CPC H01F 27/24; H01F 27/2823; H01F 27/022; H01F 3/14

(57) ABSTRACT

A magnetic assembly including a first magnetic core, a second magnetic core, a wire frame, multiple block magnetic cores, and a wire wrap is provided. The second magnetic core is assembled with the first magnetic core. The wire frame is disposed between the first magnetic core and the second magnetic core. The wire frame includes multiple accommodating spaces that are separated from each other, arranged at equal intervals, and have the same size. The block magnetic cores are respectively placed and fixed in the accommodating spaces of the wire frame in a drawer-like manner. The wire wrap is disposed around the wire frame, so as to wrap a part of the wire frame and the block magnetic cores in the wire wrap.

### CROSS-REFERENCE TO RELATED APPLICATION

This application claims the priority benefit of Taiwan application no. 111127573, filed on Jul. 22, 2022. The entirety of the above-mentioned patent application is hereby incorporated by reference herein and made a part of this specification.

### BACKGROUND

### Technical Field

The disclosure relates to a magnetic assembly, and particularly relates to a magnetic assembly with low magnetic loss.

### Description of Related Art

In the existing technology, multi-air-gap magnetic cores are bonded together with epoxy resin and fixed in a wire frame. Due to dimensional tolerance of the magnetic core and the difference of the thickness of each layer of epoxy resin, the gap between the magnetic cores in the wire frame is uneven, and there is even a skewed deviation in the assembly, which leads to a larger amount of magnetic loss.

### SUMMARY

The disclosure is directed to a magnetic assembly, which has an advantage of low magnetic loss.

The disclosure provides a magnetic assembly including a first magnetic core, a second magnetic core, a wire frame, multiple block magnetic cores, and a wire wrap. The second magnetic core is assembled with the first magnetic core. The wire frame is disposed between the first magnetic core and the second magnetic core. The wire frame includes multiple accommodating spaces that are separated from each other, arranged at equal intervals, and have a same size. The block magnetic cores are respectively placed and fixed in the accommodating spaces of the wire frame in a drawer-like manner. The wire wrap is disposed around the wire frame, so as to wrap a part of the wire frame and the block magnetic cores in the wire wrap.

In an embodiment of the disclosure, the wire frame includes a first portion, a second portion, and a third portion. The first magnetic core leans against the first portion, and the second magnetic core leans against the second portion. The third portion includes the accommodating spaces and connects the first portion and the second portion.

In an embodiment of the disclosure, the third portion of the wire frame further includes a first sidewall, a second sidewall, and multiple partition plates. The first sidewall is vertically connected to the first portion and the second portion. The second sidewall is opposite to the first sidewall and is vertically connected to the first portion and the second portion. The partition plates are vertically connected to the first sidewall and the second sidewall, so as to separate the accommodating spaces arranged at equal intervals between the first portion and the second portion.

In an embodiment of the disclosure, the block magnetic cores respectively directly contact the partition plates and are fixed in the accommodating spaces.

In an embodiment of the disclosure, the first portion, the second portion, and the third portion of the wire frame are formed into an integrally formed structure by means of injection molding.

In an embodiment of the disclosure, the third portion is retracted by a distance relative to the first portion and the second portion to form a winding space, and the wire wrap is located in the winding space.

In an embodiment of the disclosure, the first magnetic core is assembled on the second magnetic core in a first direction, the block magnetic cores are placed in the accommodating spaces of the wire frame in a second direction, and the first direction is perpendicular to the second direction.

In an embodiment of the disclosure, the wire wrap and the block magnetic cores are arranged at intervals.

In an embodiment of the disclosure, the first magnetic core has a bottom, and the second magnetic core has a top, and the bottom abuts the top so that the first magnetic core is assembled on the second magnetic core.

In an embodiment of the disclosure, a size of each of the accommodating spaces is greater than or equal to a size of each of the block magnetic cores.

Based on the above description, in the design of the magnetic assembly of the disclosure, the wire frame includes multiple accommodating spaces that are separated from each other, arranged at equal intervals, and have the same size, and the block magnetic cores are respectively placed and fixed in the accommodating spaces of the wire frame in a drawer-like manner. In this way, it is possible to reduce the amount of magnetic loss by having the same gap between the block magnetic cores and not shifting them within the wire frame. Thus, the magnetic assembly of the disclosure may have the advantage of low magnetic loss.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic three-dimensional view of a magnetic assembly according to an embodiment of the disclosure.

FIG. 2 is a schematic exploded view of the magnetic assembly of FIG. 1.

### DESCRIPTION OF THE EMBODIMENTS

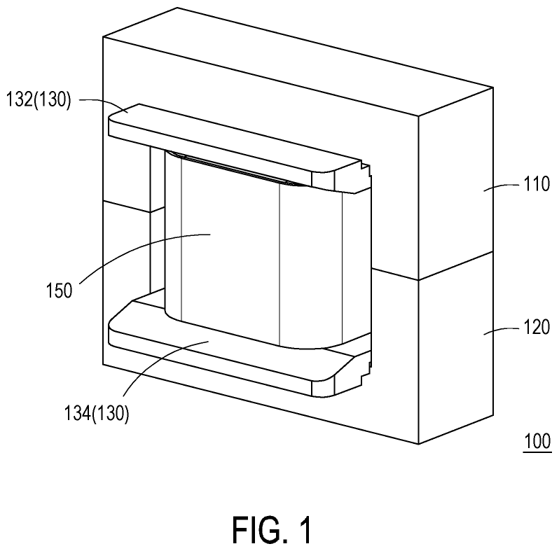

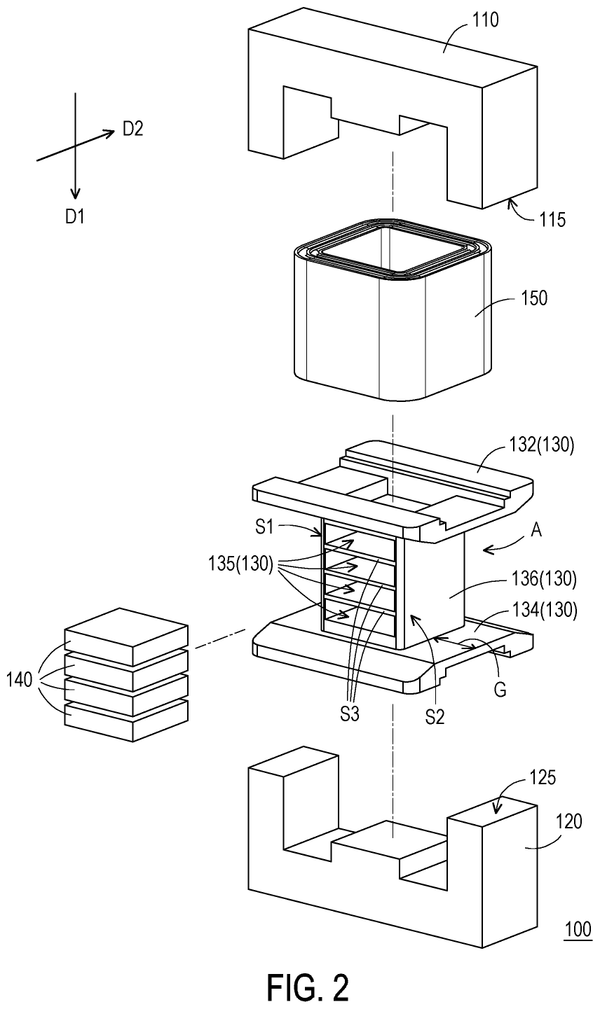

FIG. 1 is a schematic three-dimensional view of a magnetic assembly according to an embodiment of the disclosure. FIG. 2 is a schematic exploded view of the magnetic assembly of FIG. 1. Referring to FIG. 1 and FIG. 2 at the same time, according to this embodiment, a magnetic assembly 100 includes a first magnetic core 110, a second magnetic core 120, a wire frame 130, multiple block magnetic cores 140, and a wire wrap 150. The second magnetic core 120 is assembled with the first magnetic core 110. The wire frame 130 is disposed between the first magnetic core 110 and the second magnetic core 120. The wire frame 130 includes multiple accommodating spaces 135 that are separated from each other, arranged at equal intervals, and have a same size. The block magnetic cores 140 are respectively placed and fixed in the accommodating spaces 135 of the wire frame 130 in a drawer-like manner. The wire wrap 150 is disposed around the wire frame 130 to wrap a part of the wire frame 130 and the block magnetic cores 140 in the wire wrap 150.

In detail, referring to FIG. 2 again, the wire frame 130 according to this embodiment includes a first portion 132, a second portion 134, and a third portion 136. The first magnetic core 110 leans against the first portion 132, and the second magnetic core 120 leans against the second portion 134. The first magnetic core 110 has a bottom 115, and the second magnetic core 120 has a top 125. The bottom 115 abuts the top 125 so that the first magnetic core 110 is assembled on the second magnetic core 120. The third portion 136 includes the accommodating spaces 135 and connects the first portion 132 and the second portion 134. The third portion 136 of the wire frame 130 further includes a first sidewall S1, a second sidewall S2, and multiple partition plates S3. The first sidewall S1 is vertically connected to the first portion 132 and the second portion 134. The second sidewall S2 is opposite to the first sidewall S1, and is vertically connected to the first portion 132 and the second portion 134. The partition plates S3 are vertically connected to the first sidewall S1 and the second sidewall S2 to separate the accommodating spaces 135 that arranged at equal intervals and have the same size between the first portion 132 and the second portion 134. The first portion 132, the second portion 134, and the third portion 136 of the wire frame 130 are formed into an integrally formed structure by means of injection molding.

Particularly, the block magnetic cores 140 according to this embodiment are respectively placed in the accommodating spaces 135 of the wire frame 130 in the drawer-like manner, where the block magnetic cores 140 respectively directly contact the partition plates S3 and are fixed in the accommodating spaces 135. As shown in FIG. 2, the first magnetic core 110 is assembled on the second magnetic core 120 in a first direction D1, and the block magnetic cores 140 are placed in the accommodating spaces 135 of the wire frame 130 in a second direction D2, where the first direction D1 is perpendicular to the second direction D2. Preferably, a size of each of the accommodating spaces 135 is slightly larger than or equal to a size of each of the block magnetic cores 140, so as to effectively fix/position the block magnetic cores 140. Here, a material of the first magnetic core 110, a material of the second magnetic core 120, and a material of the block magnetic cores 140 are, for example, ferrite, silicon steel sheet, or iron-nickel alloy. In some embodiments, the material of the block magnetic cores 140 may be the same as or different from the material of the first magnetic core 110 and the second magnetic core 120, which is not limited by the disclosure.

In addition, referring to FIG. 1 and FIG. 2 again, the third portion 136 of the wire frame 130 is retracted by a distance G relative to the first portion 132 and the second portion 134 to form a winding space A, and the wire wrap 150 is located in the winding space A. The wire wrap 150 surrounds and contacts the first sidewall S1 and the second sidewall S2 of the third portion 136, and the block magnetic cores 140 are wrapped and sealed therein. Namely, the block magnetic cores 140 located in the accommodating spaces 135 are not visible from an appearance of the magnetic assembly 100 because the block magnetic cores 140 are wrapped by the wire wrap 150. It should be noted that, according to this embodiment, the wire wrap 150 and the block magnetic cores 140 are arranged at intervals, which means that the wire wrap 150 does not contact the block magnetic cores 140.

Generally speaking, since the air gap leakage flux is equivalent to a semicircle or an arcuate shape with the gap of the air gap as a straight side on the cross section of the magnetic core, with the increase in the height of the air gap, the cross-sectional area of the leakage flux increases in square multiples, and for the actual three-dimensional space, the space increases in cubic multiples. Therefore, according to this embodiment, the accommodating spaces 135 of the same size of the wire frame 130 allow the block magnetic cores 140, which are placed in the drawer-like manner and fixed therein, to form multiple air-gaps with a single interval to reduce the amount of magnetic loss, so that the magnetic assembly 100 has the advantage of low magnetic loss and may improve work efficiency.

In brief, since the block magnetic cores 140 according to this embodiment are respectively placed and fixed in the accommodating spaces 135 of the wire frame 130 in the drawer-like manner, this embodiment may effectively avoid skewing of the assembly compared with the existing technology of bonding the magnetic cores with epoxy resin, so that the block magnetic cores 140 have the same gap between them (i.e., the gaps remain consistent) and do not shift within the wire frame 130. In this way, it is possible to reduce the amount of magnetic loss, and the magnetic assembly 100 according to this embodiment may have the advantage of low magnetic loss.

In summary, in the design of the magnetic assembly of the disclosure, the wire frame includes multiple accommodating spaces that are separated from each other, arranged at equal intervals, and have the same size, and the block magnetic cores are respectively placed and fixed in the accommodating spaces of the wire frame in the drawer-like manner. In this way, it is possible to reduce the amount of magnetic loss by having the same gap between the block magnetic cores and not shifting them within the wire frame. Thus, the magnetic assembly of the disclosure may have the advantage of low magnetic loss.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A magnetic assembly, comprising:
a first magnetic core;
a second magnetic core assembled with the first magnetic core;
a wire frame disposed between the first magnetic core and the second magnetic core, and comprising a plurality of accommodating spaces separated from each other, arranged at equal intervals, and having a same size;
a plurality of block magnetic cores respectively placed and fixed in the accommodating spaces of the wire frame in a drawer-like manner; and
a wire wrap disposed around the wire frame to wrap a part of the wire frame and the block magnetic cores in the wire wrap.

2. The magnetic assembly according to claim 1, wherein the wire frame comprises:
a first portion, wherein the first magnetic core leans against the first portion;
a second portion, wherein the second magnetic core leans against the second portion; and
a third portion comprising the accommodating spaces and connecting the first portion and the second portion.

3. The magnetic assembly according to claim 2, wherein the third portion of the wire frame further comprises:
a first sidewall vertically connected to the first portion and the second portion;
a second sidewall opposite to the first sidewall and vertically connected to the first portion and the second portion; and
a plurality of partition plates vertically connected to the first sidewall and the second sidewall to separate the accommodating spaces arranged at equal intervals between the first portion and the second portion.

4. The magnetic assembly according to claim 3, wherein the block magnetic cores respectively directly contact the partition plates and are fixed in the accommodating spaces.

5. The magnetic assembly according to claim 2, wherein the first portion, the second portion, and the third portion of the wire frame are formed into an integrally formed structure by means of injection molding.

6. The magnetic assembly according to claim 2, wherein the third portion is retracted by a distance relative to the first portion and the second portion to form a winding space, and the wire wrap is located in the winding space.

7. The magnetic assembly according to claim 1, wherein the first magnetic core is assembled on the second magnetic core in a first direction, the block magnetic cores are placed in the accommodating spaces of the wire frame in a second direction, and the first direction is perpendicular to the second direction.

8. The magnetic assembly according to claim 1, wherein the wire wrap and the block magnetic cores are arranged at intervals.

9. The magnetic assembly according to claim 1, wherein the first magnetic core has a bottom, the second magnetic core has a top, and the bottom abuts the top such that the first magnetic core is assembled on the second magnetic core.

10. The magnetic assembly according to claim 1, wherein a size of each of the accommodating spaces is greater than or equal to a size of each of the block magnetic cores.
